(19) United States
(12) Patent Application Publication
(10) Pub. No.: US 2021/0321715 A1
(43) Pub. Date: Oct. 21, 2021

(54) SHOE SOLE COMPOSITION, PROCESS AND RESULTING PRODUCT

(71) Applicant: Maria Eugênia Moniz De Aragão GONZAGA, Florianopolis (BR)

(72) Inventor: Maria Eugênia Moniz De Aragão GONZAGA, Florianopolis (BR)

(21) Appl. No.: 17/270,019

(22) PCT Filed: Aug. 22, 2019
(86) PCT No.: PCT/BR2019/050348

§ 371 Date: Feb. 23, 2021

(30) Foreign Application Priority Data
Aug. 24, 2018 (BR) BR1020180775499

(51) Int. Cl. A43B 13/04

(52) U.S. Cl. CPC A43B 13/04

(57) ABSTRACT

Invention patent for a shoe sole rubber paint composition, characterized by comprising a mixture of 35-48% PVC resin, 30-40% dioctyl terephthalate DOTP-based plasticizer, 1-3% calcium/zinc tris (nonylphenyl) phosphite stabilizer, 15-30% nitric rubber powder and 1-4% non-toxic organic pigment, a process for manufacturing shoe soles using said composition and a shoe sole product resulting from said process.

This invention relates to the technical field of compositions and process for manufacturing of soles, more specifically to a composition, process and product resulting from shoe soles, which presents as novelty: the composition of a rubberized ink for manufacturing of soles by means of silk screen with anti-skid gel/relief effect on flexible fabric substratum of neoprene, neoplex and further rubberized fabrics.

### STATE THE ART AND ISSUES

As the subject-matter experts are aware of, in the current market there is a wide variety of compositions and processes for manufacturing of shoe soles; Among them we can mention the compositions described in U.S. Pat. No. 3,760,724; and processes in BR102012022763-0 A2; BR 202013021687-4 U2; and in U.S. Pat. No. 7,930,841.

The U.S. Pat. No. 3,760,724 describes and claims a heat-set, silk screen ink, comprising a polyvinyl resin (polyvinyl acetate, polyvinyl butyral, polyvinyl chloride, polyvinylidene chloride, polyvinylidene fluoride, polyvinyl dichloride and their copolymers); it spreads in a compatible liquid plasticizer (phthalic acid diester) to form a plastisol; a fixative agent essentially consisting of liquid polystyrene; and a carbon black pigment. The use of the plasticizer phthalic acid diester, can cause eye irritation, skin and lung sensitization, also can cause liver and kidney damages. For this reason, it would be discarded in the proposed application.

The BR102012022763-0 A2 describes and claims a process for production of shoe soles, which uses a butadiene- and styrene-based vulcanized rubber plate, which can be added (silica, calcium carbonate, kaolin, carbon black, diverse pigments, plasticizer oils, polystyrene, butyl rubber, natural rubber, among others), being the plate inserted in a high-frequency equipment, where a molding matrix is provided, which will give form to the sole. This invention describes a sole, manufactured by a molding matrix (upper and lower), which is similar to most existent soles. Being these completely different from the proposed process.

The BR 202013021687-4 describes and claims a mixture of PU colorless base and a flexible polymer, which is applied in an unmold paper, where after drying will be ready to be laser or led printed, being posteriorly applied by thermal press in soles previously prepared with heat-activated lacquer primer. This process only transfer images or logos printed in PU, on soles. For this reason, it is completely different from proposed invention.

The U.S. Pat. No. 7,930,841 B2 describes and claims a shoe for aquatic sports, which use an anti-skid flexible sole model, which can be made of a substantially flexible material, preferably of some type of rubber, including various elastomers. This specification would cover the use of most existent soles. But it is completely different from the manufacturing process of the intended sole in this invention.

### IMPROVEMENTS SHOWED ABOUT THE CURRENT STATE OF THE ART

The invention at issue was developed to be different from the compositions and manufacturing processes of shoe soles, preferably to shoes or slippers manufactured in rubberized fabrics (neoplex, neoprene, among others). Being the main differences or improvements:
a manufacturing process which replaces traditional metal matrix or molds (upper and lower) by silk screens;
the relief layers, obtained by composition of rubberized ink, offer to soles, resistance and protection to feet, and at the same time, there is a sensation of being barefoot;
its chemical composition allows the manufacture of an anti-skid relief sole, preferably developed to smooth surfaces in aquatic environment; and
it can be adapted to form the sole of any model of slippers and further shoes, regardless of the form, size, color or brand, changing only the art of the silk screen, and thus, reduces the production costs, especially the change of collection.

### DISCLOSURE OF THE INVENTION

This invention relates to the composition of a rubberized ink, comprised of a preferential mixture of: PVC resin; dioctyl terephthalate (DOTP)-base plasticizer; tris nonylphenyl phosphite Calcium/Zinc stabilizer; nitrile rubber powder; and nontoxic organic pigment.

According to the invention, the manufacturing process of shoe soles, comprises the steps of:
creation of art, printing and engraving of a nylon netting of 40 to 45 wires;
the cut of substrates of neoplex or neoprene rubberized fabric, preferably 3 mm, leaving them with a printing area for one or more soles pairs;
the dilution of rubberized ink with softener, in the order of 2 to 3% of the ink mixture to be used;
the printing of a first layer of ink on the substrate;
drying by thermal blower or flashcure for ten seconds at very coating, to form the relief;
it is repeated the process until reaching the preferential height, being from four to six printing and drying;
the substrates with layers of printed drawings, go to an oven, where they are cured or polymerized for three minutes at a temperature of 180°; and
finally they are cut out in the form of the sole, being available for the composition of a shoe.

According to the invention the resulting product, comprises soles in neoplex or neoprene rubberized fabrics, with drawings in rubberized and anti-skid relief, manufactured by process of printing and heating of the layers, which are available to compose the sole of the most diverse types of slippers or shoes manufactured by the same material of the substrate, or of similar materials.

The objective, advantages, and further important characteristics of the invention at issue can be more easily comprised when read along with the attached drawings, in which:

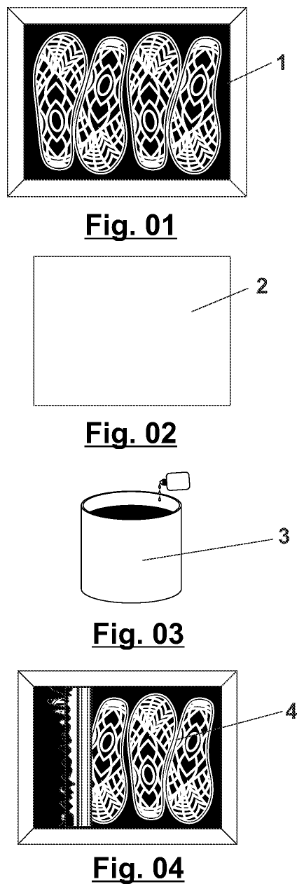

Th FIG. 01 represents an upper view of an engraved screen, with the images of the soles and of drawings that will compose the relieves.

The FIG. 02 represents an upper view of a part of the substrate of neoplex or neoprene rubberized fabric, of the composition, process and product resulting from shoe soles.

The FIG. 03 represents a view of the dilution of the rubberized ink with softener.

The FIG. 04 represents an upper view of the silk application of the rubberized ink on the substrate.

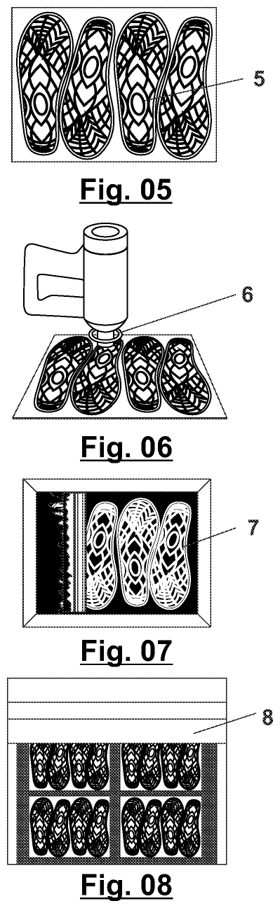

The FIG. 05 represents an upper view of the sole with silk screen of the rubberized ink.

The FIG. 06 represents an upper view of the printed substrate, receiving heat by a thermal blower, for formation of rubberized relieves of the sole.

The FIG. 07 represents an upper view representing the further printed layers.

The FIG. 08 represents an upper view of the printed substrate, going through a flashcure heater or oven.

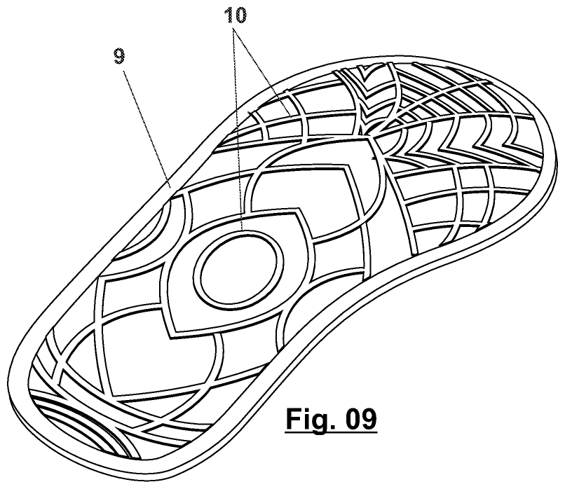

The FIG. 09 represents a view in perspective of a sole with its rubberized relieves, cut out and ready to compose the shoe sole, which can be made by gluing, welding or sewing, or a combination among them.

### DETAILED DESCRIPTION OF THE FIGURES

As it is evident in the attached figures which illustrate and are part of this descriptive report of the invention at issue of “Composition, Process and Product Resulting from Shoe Soles”, it is the composition of a rubberized ink, comprised of a preferential mixture of: 35 to 48% of PVC resin; 30 to 40% of dioctyl terephthalate (DOTP)-base plasticizer; 1 to 3% of a tris nonylphenyl phosphite Calcium/Zinc stabilizer; 15 to 30% of nitrile rubber powder; and 1 to 4% of nontoxic organic pigment.

The plasticizer of the composition can be replaced in the same proportion, by dioctyl phthalate DOP, also known as bis (2-ethylhexyl) phthalate.

In FIGS. 01, 02, 03, 04, 05, 06, 07 and 08 in annex are presented the steps of the process, which is started with engraving of drawings, logo and text on a nylon netting of 40 to 45 wires (1); the cut and preparation of the substrates of neoplex or neoprene rubberized fabric (2), preferably 3 mm, leaving them with a printing area for one or more soles pairs; the dilution of the rubberized ink with (3) the dioctyl terephthalate (DOTP)-based softener, in the order of 2 to 4% of the ink mixture to be used; the silk screen (4) of a first layer of ink on the substrate; where after the step of printing of the drawings of the sole on the substrate (5) it is made the drying for formation of relieves (6), which is made by thermal blower or flashcure for ten seconds at every coating; being repeated the process of printing and drying (7) for four or more sections until reaching a preferential height; after this phase, the substrates with the layers of printed drawings go to drying in oven (8), where they are cured or polymerized for three minutes at a temperature of 180°; and finally they are cut out the form of the sole (9), and available for the composition of shoes, preferably slippers manufactured with the same rubberized fabric.

In FIG. 09 in annex it is demonstrated the sole (9) in neoplex or neoprene rubberized fabric, with drawings, text and logos in an anti-skid relief (10).

Through this process and with simple changes it is possible the formation of divers settings of drawings and/or logos in relieves in soles; application of individual colors or set of colors, which make the sole more attractive; being ideal to compose the sole of a high variety of shoes, preferably slippers manufactured in the same material.

The sole (9) with drawings in relief (10), described and presented here, are not Limited to these disposals, settings, and measures, once the same preponderant characteristics are kept.

1. “SHOE SOLES” manufactured in a rubberized ink wherein the composition comprises a preferential mixture of: 35 to 48% of PVC resin; 30 to 40% of dioctyl terephthalate (DOP)-base plasticizer; 1 to 3% of a tris nonylphenyl phosphite Calcium/Zinc stabilizer; 15 to 30% of nitrile rubber powder; and 1 to 4% of nontoxic organic pigment.

2. “PROCESS” for manufacturing of shoe soles, according to claim 1, wherein it comprises: the steps of engraving of drawings, logo and text on a nylon netting of 40 to 45 wires (1); the cut and preparation of the substrates of neoplex or neoprene rubberized fabric (2) preferably of 3 mm, leaving them with a printing area for one or more soles pairs; the dilution of the rubberized ink with (3) the dioctyl terephthalate (DOTP)-based softener, in the order of 2 to 4% of the ink mixture to be used; the silk screen (4) of a first layer of ink on the substrate; where after the step of printing of the drawings of the sole on the substrate (5) it is made the drying for formation of relieves (6), which is made by thermal blower or flashcure for ten seconds at every coating; being repeated the process of printing and drying (7) for four or more sections until reaching a preferential height; after this phase, the substrates with the layers of printed drawings go to drying in oven (8), where they are cured or polymerized for three minutes at a temperature of 180°; and finally they are cut out in the form of the sole (9), and available for the composition of shoes, preferably slippers manufactured with the same rubberized fabric.

3. “PRODUCT RESULTING FROM SHOE SOLE”, according to claims 1 and 2, wherein it comprises a product resulting from a sole (9) in neoplex or neoprene rubberized fabric, with drawings, text and logos in an anti-skid relief (10).
